(19) United States
(12) Patent Application Publication
(10) Pub. No.: US 2023/0113743 A1
(43) Pub. Date: Apr. 13, 2023

(54) IMAGE FORMING APPARATUS

(71) Applicant: KYOCERA Document Solutions Inc., Osaka (JP)

(72) Inventor: Masato Usui, Osaka (JP)

(21) Appl. No.: 17/949,753

(22) Filed: Sep. 21, 2022

(30) Foreign Application Priority Data
Sep. 28, 2021 (JP) 2021-157554

(51) Int. Cl. B41J 2/045; G06K 15/10; B41J 2/155

(52) U.S. Cl. CPC B41J 2/04508; B41J 2/155; B41J 2/04586; G06K 15/102

(57) ABSTRACT

In image forming apparatus, a recording head is configured to eject ink corresponding to an image to be printed, using arranged nozzles. A control unit is configured to determine nozzles corresponding to the image to be printed, correspondingly to a position of a print sheet, and cause the recording head to eject ink from the nozzles. A correction processing unit is configured to perform a correction process corresponding to each of the plural ink ejection malfunction positions in the image. A head cleaning processing unit is configured to perform head cleaning for the recording head. Further, if the number of the detected ink ejection malfunction positions exceeds a predetermined upperlimit value when using a predetermined ink droplet size, the correction processing unit causes the head cleaning processing unit to perform head cleaning for the recording head and thereby decreases the number of the ink ejection malfunction positions.

### CROSS-REFERENCE TO RELATED APPLICATIONS

This application relates to and claims priority rights from Japanese Patent Application No. 2021-157554, filed on September 28th, 2021, the entire disclosures of which are hereby incorporated by reference herein.

### BACKGROUND

### 1. Field of the Present Disclosure

The present disclosure relates to an image forming apparatus.

### 2. Description of the Related Art

An inkjet-type image forming apparatus detects a malfunction nozzle that becomes unable to properly eject ink, among nozzles that eject ink in a recording head, and changes an ink ejection amount for an adjacent dot on the basis of an occurrence status of the malfunction nozzle.

When printing on a cut sheet, a nozzle used to depict each pixel in an image to be printed is differently determined sheet by sheet on the basis of a sheet transportation condition and correspondingly to a position (i.e. a position in a direction perpendicular to a transportation direction) of an incoming sheet in transportation. As mentioned, if the ink ejection amount is corrected due to the malfunction nozzle, then in a short time from determination of the sheet position to ink ejection, it is required to determine a pixel corresponding to the malfunction nozzle in the image to be printed and to perform a correction process for a periphery of the determined pixel.

Therefore, if many ink ejection malfunction positions appear to be corrected, the aforementioned correction process can not be completed in the short time. Although such many ink ejection malfunction positions can be corrected by performing the correction process using high-speed hardware, such high-speed hardware results in a high cost of the apparatus.

### SUMMARY

An image forming apparatus according to an aspect of the present disclosure includes a recording head, a control unit, a correction processing unit, and a head cleaning processing unit. The recording head is configured to eject ink corresponding to an image to be printed, using arranged nozzles. The control unit is configured to determine nozzles corresponding to the image to be printed, correspondingly to a position of a print sheet, and cause the recording head to eject ink from the nozzles. The correction processing unit is configured to perform a correction process corresponding to each of the plural ink ejection malfunction positions in the image. The head cleaning processing unit is configured to perform head cleaning for the recording head. Further, if the number of the detected ink ejection malfunction positions exceeds a predetermined upperlimit value when using a predetermined ink droplet size, the correction processing unit causes the head cleaning processing unit to perform head cleaning for the recording head and decrease the number of the ink ejection malfunction positions.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a block diagram that indicates an electronic configuration of the image forming apparatus 10 in the embodiment according to the present disclosure;

FIG. 4 shows a diagram that explains detection of an ink ejection malfunction position based on a density distribution of a test pattern image;

FIG. 5 shows a flowchart that explains a behavior of the image forming apparatus 10 in Embodiment 1; and

FIG. 6 shows a flowchart which explains a behavior of the image forming apparatus 10 in Embodiment 2.

### DETAILED DESCRIPTION

Hereinafter, embodiments according to an aspect of the present disclosure will be explained with reference to drawings.

### Embodiment 1

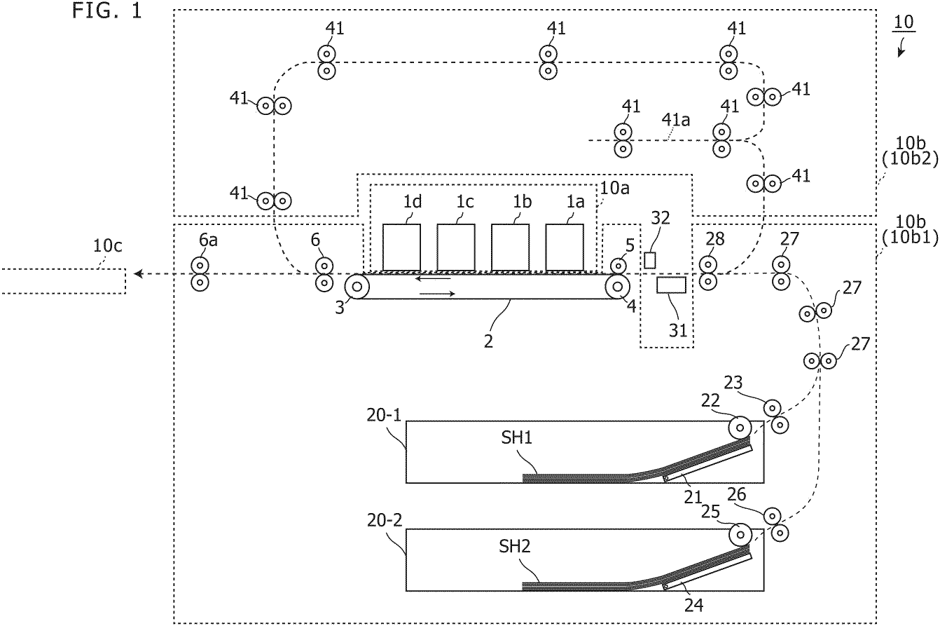

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes fixed line-type head units 1a to 1d corresponding to four ink colors : Cyan, Magenta, Yellow, and Black.

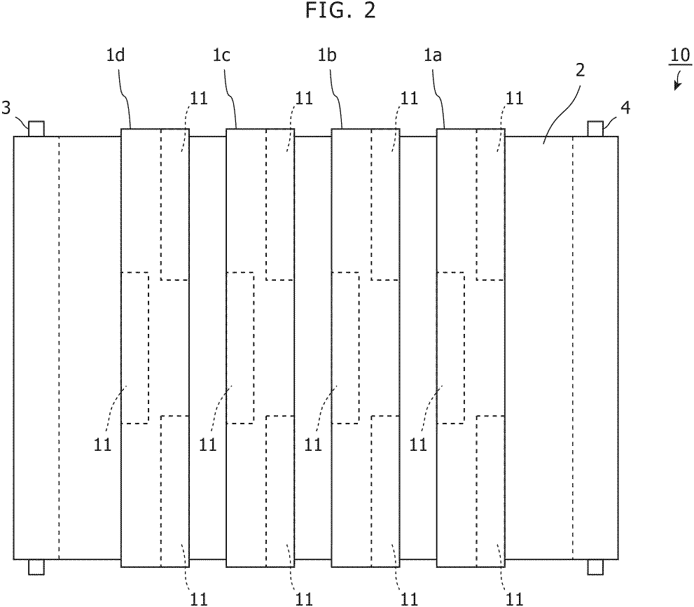

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the inkjet recording units 1a, 1b, 1c and 1d may include only one head unit 11. The head unit 11 of the inkjet recording unit 1a, 1b, 1c or 1d includes 2-dimensionally arranged nozzles, and ejects ink corresponding to the image to be printed using the nozzles.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both side end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a top end of the print sheet SH1 or SH2 passes through a predetermined position on the transportation path. The line sensor 31 detects the positions of the both side end edges at a time point that the top end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

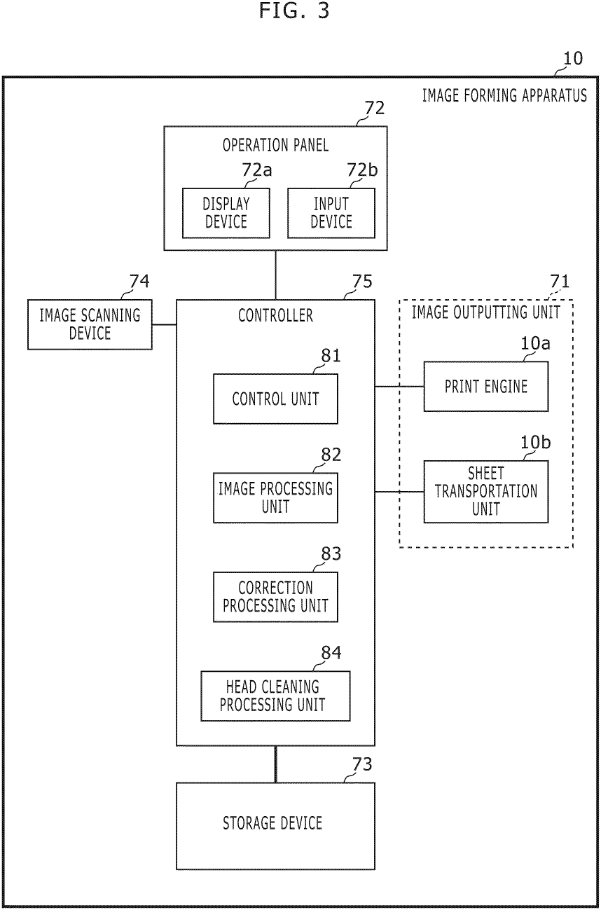

FIG. 3 shows a block diagram that indicates an electronic configuration of the image forming apparatus 10 in the embodiment according to the present disclosure. As shown in FIG. 3, the image forming apparatus 10 includes not only an image outputting unit 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, a correction processing unit 83, and a head cleaning processing unit 84.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. The image processing unit 82 performs a predetermined image process such as RIP (Raster Image Processing), color conversion, halftoning and/or the like for image data of a printing image.

Specifically, the control unit 81 causes the print engine 10a to print a user document image based on printing image data specified by a user.

Further, in this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process.

Specifically, in the automatic centering function, the control unit 81 changes a depicting position of the image to be printed, in a primary scanning direction by a difference between a reference center position of the print engine 10a and the actual sheet center position. In this embodiment, because the nozzles of the recording heads 1a to 1d do not move, a nozzle corresponding to each pixel in the image to be printed is changed correspondingly to the depicting position of the image to be printed.

As mentioned, the control unit 81 determines nozzles corresponding to the image to be printed (a nozzle corresponding to each pixel), correspondingly to a position of a print sheet, and causes the recording heads 1a to 1d to eject ink from the determined nozzles.

The correction processing unit 83 performs as a hardware process the correction process corresponding to each of the plural ink ejection malfunction positions in the image to be printed. In this correction process, for example, image data (a pixel value) of a pixel adjacent to the ink ejection malfunction position is corrected such that a density of this adjacent pixel gets higher, and thereby an ink ejection amount for the adjacent pixel is increased.

For example, the correction processing unit 83 (a) prints a test pattern using the image outputting unit 71, and (b) determines as a preferential ink ejection malfunction position an ink ejection malfunction position that ink ejection malfunction is also detected in the test pattern among the ink ejection malfunction positions on the basis of a scanned image of the test pattern. It should be noted that the test pattern is a band-shaped solid image along the primary scanning direction.

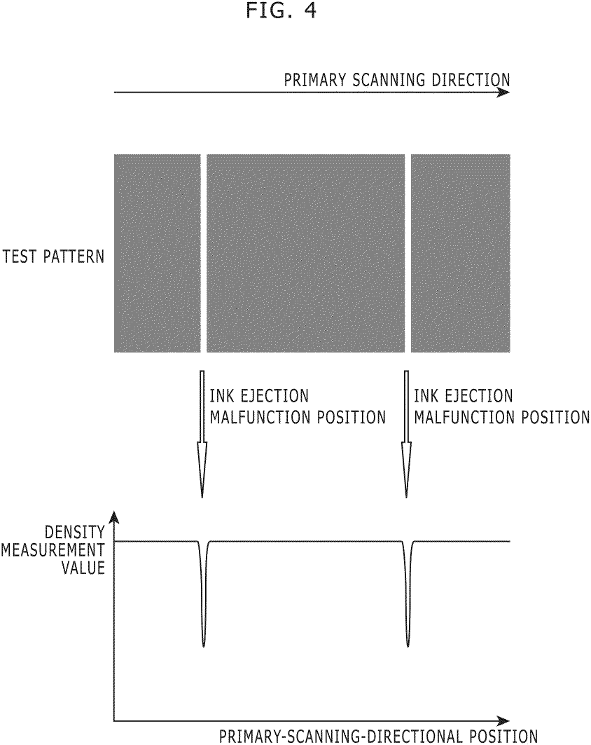

FIG. 4 shows a diagram that explains detection of an ink ejection malfunction position based on a density distribution of a test pattern image. In this embodiment, because the line sensor 31 is installed to detect a position of a print sheet, for example, the test pattern is printed on the print sheet, the circulation transportation unit 10b2 transports the print sheet, the line sensor 31 scans an image of the printed test pattern, and the ink ejection malfunction position is detected on the basis of a primary-scanning-directional density distribution of this image. For example, as shown in FIG. 4, a position of a dip in the density distribution is detected as the ink ejection malfunction position, and a nozzle corresponding to the ink ejection malfunction position is determined as an ink ejection malfunction nozzle.

If the line sensor 31 is used for the detection of the ink ejection malfunction position as mentioned, the ink ejection malfunction position is automatically detected, and thereafter the print sheet on which the test pattern has been printed is outputted. Instead of the line sensor 31, the print sheet on which the test pattern has been printed may be immediately outputted and set on the image scanning device 74 by a user, and the image on the print sheet may be scanned by the image scanning device 74.

Alternatively, a malfunction nozzle detecting device may be installed, and the malfunction nozzle detecting device optically detects whether an ejected ink droplet exists or not; and the ink ejection malfunction nozzle may be determined using the malfunction nozzle detecting device.

Returning to FIG. 3, the head cleaning processing unit 84 controls the print engine 10a and the like, and thereby performs head cleaning for the recording heads 1a to 1d. Usually, the head cleaning processing unit 84 performs the head cleaning at a periodical timing, at a timing specified by a user, or the like.

The head cleaning is performed as a preliminary ink ejection, applying pressure to the nozzles (without ink), a purge operation using purge mechanism, a wiping operation using wiper mechanism, and/or the like. The purge operation is an operation that retracts the transportation belt opposite to the heads, moves an ink tray to a position under the heads, and thereafter causes the nozzles to output ink by gaining ink pressure using a pump or the like.

Further, if the number of the detected ink ejection malfunction positions exceeds a predetermined upperlimit value (e.g. 10), the correction processing unit 83 automatically causes the head cleaning processing unit 84 to perform head cleaning for the recording heads 1a to 1d and thereby decreases the number of the ink ejection malfunction positions. The head cleaning in this case may be performed for only recording head(s) that include(s) the detected ink ejection malfunction position (s) among the recording heads 1a to 1d or may be performed for all the recording heads 1a to 1d.

In this embodiment, the correction processing unit 83 continuously and repeatedly causes the head cleaning processing unit 84 to perform head cleaning for the recording heads 1a to 1d until the number of the ink ejection malfunction positions gets equal to or less than the upperlimit value.

The following part explains a behavior of the image forming apparatus 10 in Embodiment 1.

(a) Determination of an ink ejection malfunction position that the correction process should be performed

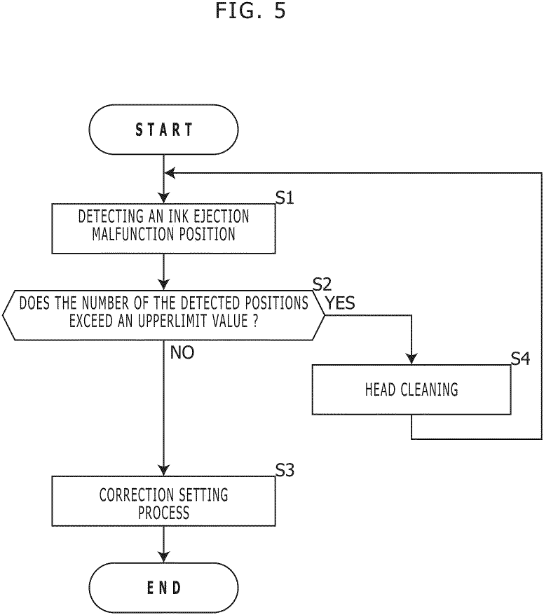

FIG. 5 shows a flowchart that explains a behavior of the image forming apparatus 10 in Embodiment 1.

Firstly, the correction processing unit 83 detects an ink ejection malfunction position (i.e. ink ejection malfunction nozzle) (in Step S1). For example, the correction processing unit 83 causes the image outputting unit 71 to print a test pattern on a print sheet, obtains a scanned image (image data of each ink color) of the test pattern using the line sensor 31 or the image scanning device 74, detects an ink ejection malfunction position on the basis of a density distribution in the primary scanning direction of the scanned image, and determines a nozzle corresponding to the ink ejection malfunction position.

Subsequently, the correction processing unit 83 determines whether the number of the detected ink ejection malfunction positions exceeds an upperlimit value (a limit number of the ink ejection malfunction positions for which the correction process is performed in the aforementioned short time) or not (in Step S2).

If the number of the detected ink ejection malfunction positions does not exceed the upperlimit value, then the correction processing unit 83 determines as a target of the correction process the currently detected ink ejection malfunction position(s), and stores data of the ink ejection malfunction position(s) and ink ejection malfunction nozzle(s) into the storage device 73 (in Step S3).

Contrarily, if the number of the detected ink ejection malfunction positions exceeds the upperlimit value, the correction processing unit 83 causes the head cleaning processing unit 84 to perform head cleaning for the recording units 1a to 1d (in Step S4). The ink ejection malfunction positions are decreased by the number of nozzles of which ink ejection malfunction was resolved by the head cleaning.

After the head cleaning, the correction processing unit 83 detects an ink ejection malfunction position again (in Step S1), and determines whether the number of the detected ink ejection malfunction positions exceeds the aforementioned upperlimit value or not again (in Step S2). If the number of the detected ink ejection malfunction positions still exceeds the aforementioned upperlimit value, then the head cleaning is performed again. As mentioned, if the number of the detected ink ejection malfunction positions exceeds the aforementioned upperlimit value, the head cleaning is continuously and repeatedly performed.

(b) Behavior for printing

When receiving a print request, the control unit 81 causes the image processing unit 82 to perform an image process for an image specified by the print request, and thereby acquires image data of the image to be printed; and causes the image outputting unit 71 to transport a print sheet and print the image to be printed on the print sheet on the basis of the image data.

In this process, the correction processing unit 83 reads the data of the ink ejection malfunction positions and the ink ejection malfunction nozzles from the storage device 73 and determines the ink ejection malfunction positions and the ink ejection malfunction nozzles before starting the printing; and upon detecting a position of a print sheet using the line sensor 31, (a) determines a nozzle corresponding to each pixel in the aforementioned image, (b) determines the ink ejection malfunction positions in the aforementioned image (i.e. corresponding nozzles), and (c) performs the correction process for the ink ejection malfunction positions. Subsequently, the control unit 81 performs the aforementioned printing on the basis of the image data after the correction process.

As mentioned, in Embodiment 1, the recording head 1a, 1b, 1c or 1d ejects ink corresponding to an image to be printed, using arranged nozzles. The control unit 81 determines nozzles corresponding to the image to be printed, correspondingly to a position of a print sheet, and causes the recording head 1a, 1b, 1c or 1d to eject ink from the nozzles. The correction processing unit 83 performs a correction process corresponding to each of the plural ink ejection malfunction positions in the aforementioned image. The head cleaning processing unit 84 performs head cleaning for the recording head 1a, 1b, 1c or 1d. Further, if the number of the detected ink ejection malfunction positions exceeds a predetermined upperlimit value when using a predetermined ink droplet size, the correction processing unit 82 causes the head cleaning processing unit 84 to perform head cleaning for the recording head 1a, 1b, 1c or 1d and thereby decreases the number of the ink ejection malfunction positions.

Consequently, the ink ejection malfunction positions are decreased until the correction process for all of the ink ejection malfunction positions can be performed in the aforementioned short time, and therefore the correction process against the ink ejection malfunction is properly performed.

### Embodiment 2

In Embodiment 2, the correction processing unit 83 changes a strength of the aforementioned head cleaning in accordance with the number of times of continuously performing the head cleaning.

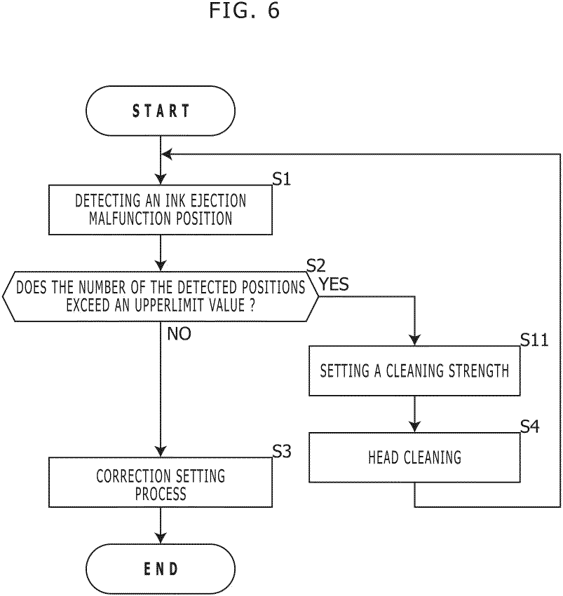

FIG. 6 shows a flowchart which explains a behavior of the image forming apparatus 10 in Embodiment 2. In Embodiment 2, if the number of the detected ink ejection malfunction positions exceeds the aforementioned upperlimit value, then the correction processing unit 83 sets a cleaning strength corresponding to the number of times of continuously performing the head cleaning (i.e. repeating times of the head cleaning in Step S4) (in Step S11), and then causes the head cleaning processing unit 84 to perform the head cleaning with the cleaning strength (in Step S4).

Here, the more the number of times of continuously performing the head cleaning is, the correction processing unit 83 sets the higher cleaning strength. Plural levels of the cleaning strengths have been set correspondingly to operation types (preliminary ink ejection, applying pressure to the nozzles, a purge operation, a wiping operation, and the like), the number of times of the head cleaning or the like; and the cleaning strength corresponding to the number of times of continuously performing the head cleaning is selected among the plural levels of the cleaning strengths.

Other parts of the configuration and behaviors of the image forming apparatus in Embodiment 2 are identical or similar to those in Embodiment 1, and therefore not explained here.

As mentioned, in Embodiment 2, a strength of the head cleaning is changed in accordance with the number of times of continuously performing the head cleaning, and therefore the number of the ink ejection malfunction positions are effectively decreased.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink corresponding to an image to be printed, using arranged nozzles;
a control unit configured to determine nozzles corresponding to the image to be printed, correspondingly to a position of a print sheet, and cause the recording head to eject ink from the nozzles;
a correction processing unit configured to perform a correction process corresponding to each of the plural ink ejection malfunction positions in the image; and
a head cleaning processing unit configured to perform head cleaning for the recording head;
wherein if the number of the detected ink ejection malfunction positions exceeds a predetermined upperlimit value when using a predetermined ink droplet size, the correction processing unit causes the head cleaning processing unit to perform head cleaning for the recording head and decrease the number of the ink ejection malfunction positions.

2. The image forming apparatus according to claim 1, wherein the correction processing unit continuously and repeatedly causes the head cleaning processing unit to perform head cleaning for the recording head until the number of the ink ejection malfunction positions gets equal to or less than the upperlimit value.

3. The image forming apparatus according to claim 2, wherein the correction processing unit changes a strength of the head cleaning in accordance with the number of times of continuously performing the head cleaning.

4. The image forming apparatus according to claim 1, wherein the correction processing unit performs the correction process as a hardware process.

5. The image forming apparatus according to claim 1, wherein the correction processing unit increases an ink ejection amount for a pixel adjacent to the ink ejection malfunction position in the correction process.

6. The image forming apparatus according to claim 1, wherein the recording head is a fixed line-type head.
